(19) United States
(12) Patent Application Publication
(10) Pub. No.: US 2022/0257999 A1
(43) Pub. Date: Aug. 18, 2022

(54) EXERCISE BIKE AUXILIARY HANDLE

(71) Applicant: HAIDONG GU, Pomona, CA (US)

(72) Inventor: HAIDONG GU, Pomona, CA (US)

(21) Appl. No.: 17/179,325

(22) Filed: Feb. 18, 2021

(51) Int. Cl. A63B 21/00; A63B 22/06

(52) U.S. Cl. CPC A63B 21/4035; A63B 22/0605

(57) ABSTRACT

An exercise bike auxiliary handle includes a handlebar, a fastening part, a bicycle handle sleeve and a bar end. The handlebar is in cooperation with the fastening part to movably clamp on a handle of an exercise bike, to provide a tactile like a bicycle handle, so that a user can grip the auxiliary handle to operate an exercise bike for muscle training.

### BACKGROUND OF THE INVENTION

### 1. Field of the Invention

The present invention relates to an auxiliary handle, and more particularly to an auxiliary handle which can be movably mounted on a handle of the exercise bike to simulate a bicycle handle.

### 2. Description of the Related Art

Poor weather, outdoor temperature and time of day are often factors that limit people from exercising. In the other hand, indoor exercise is not limited by climate and temperature, so people usually do not give up the idea of performing indoor exercise. Among indoor exercise fitness apparatuses, the apparatuses mainly used to train the lower body include, for example, treadmills, scooters and exercise bikes.

For example, Taiwan Utility Model Patents No. M562142 and M598171 and Taiwan Invention Patent No. 1587890, China Utility Model Patents No. CN210384705U and CN209596488U, and China Invention Patent No. CN107029393B. The aforementioned exercise bicycles have handles for users to grip, and some handles have a height adjustment function to fit with the users. However, some cycling enthusiasts cannot adapt to hand feeling of gripping on the handle of the exercise bike wrapped in foam when using indoor exercise bikes, and sweaty hand gripping the foam is prone to slide on the foam; the cycling enthusiasts are even more accustomed to the positions, shapes and hand feeling of the handles of the bicycle. Therefore, the handle of the conventional exercise bike still has shortcomings in use.

### SUMMARY OF THE INVENTION

The present invention provides an auxiliary handle which can be movably mounted on a handle of an exercise bike, to provide a user to mount personal preference bicycle handle and bar end, so that the user can stably hold the handle during exercise bike stepping training.

In order to achieve the aforementioned objective and effect, the present invention provide an exercise bike auxiliary handle including a handlebar, a fastening part, a bicycle handle sleeve and a bar end. The handlebar includes a clamp part and a handlebar part. The handle part includes an extension section, a bent section and a lateral section, and two ends of the bent section are integrally connected to the extension section and the lateral section, and the lateral section includes a long part and a short part which are integrally connected to each other, and the long part is connected to the bent section. The fastening part is configured to clamp with the clamp part correspondingly, and the fastening part and the clamp part are assembled by a plurality of bolts. The bicycle handle sleeve is mounted on a peripheral side of the long part in an axial direction. The bar end includes an end mounted on a peripheral side of the short part.

### BRIEF DESCRIPTION OF THE DRAWINGS

The structure, operating principle and effects of the present invention will be described in detail by way of various embodiments which are illustrated in the accompanying drawings.

FIG. 1 is a perspective assembly view of an exercise bike auxiliary handle of the present invention.

FIG. 2 is a perspective exploded view of an exercise bike auxiliary handle of the present invention.

FIG. 3 is a perspective exploded view of an exercise bike auxiliary handle before being mounted on an exercise bike, according to the present invention.

FIG. 4 is a perspective assembly view of an exercise bike auxiliary handle mounted on an exercise bike, according to the present invention.

FIG. 5 is a schematic side view showing an operation of adjusting a mounting angle of an exercise bike auxiliary handle mounted on an exercise bike, according to the present invention.

FIG. 6 is a perspective exploded view of a water bottle cage before being mounted on an exercise bike auxiliary handle, according to the present invention.

FIG. 7 is a perspective assembly view of a water bottle cage mounted on an exercise bike auxiliary handle, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

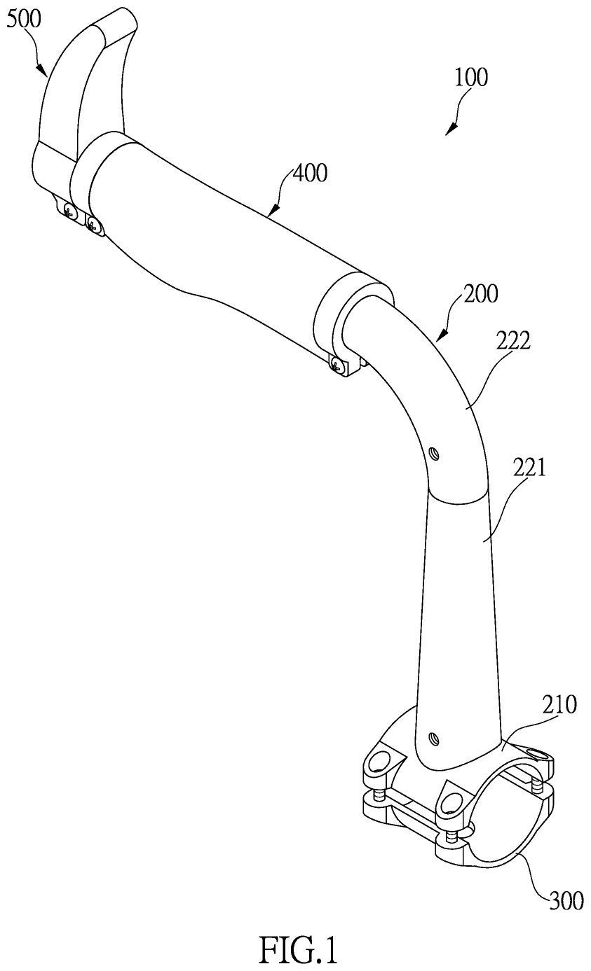

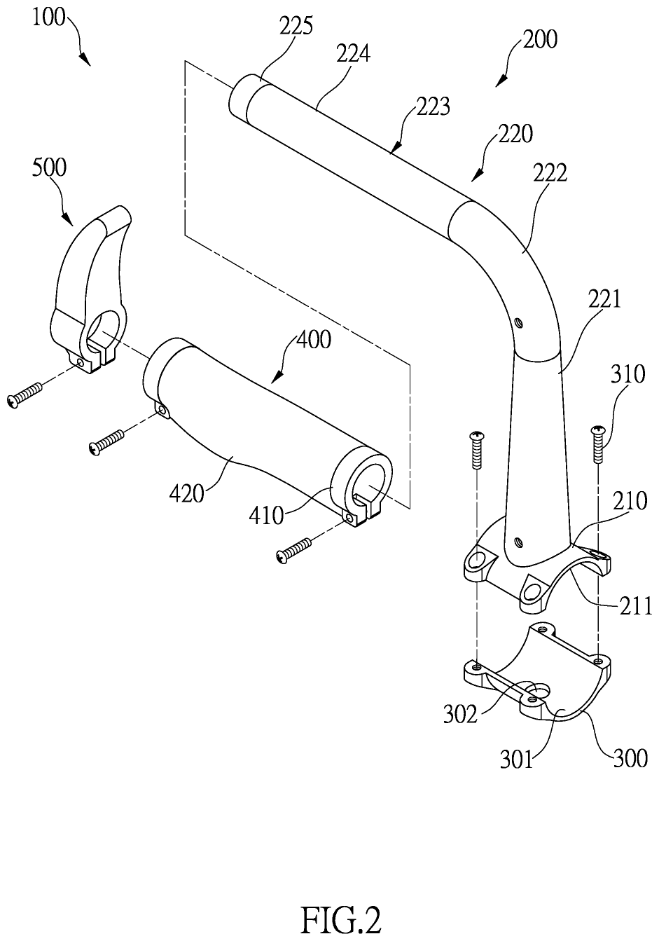

Please refer to FIGS. 1 and 2. As shown in FIGS. 1 and 2, an exercise bike auxiliary handle 100 for an includes a handlebar 200, a fastening part 300, a bicycle handle sleeve 400 and a bar end 500. The handlebar 200 includes a clamp part 210 and a handlebar part 220. The handle part 220 includes an extension section 221, a bent section 222 and a lateral section 223, and two ends of the bent section 222 are integrally connected to the extension section 221 and the lateral section 223. The lateral section 223 includes a long part 224 and a short part 225 which are integrally connected to each other. The long part 224 is connected to the bent section 222. A fastening part 300 is configured to clamp with the clamp part 210 correspondingly, and the fastening part 300 and the clamp part 210 are assembled by a plurality of bolts 310. The bicycle handle sleeve 400 is mounted on a peripheral side of the long part 224 in an axial direction. A bar end 500 includes an end mounted on a peripheral side of the short part 225. An extension direction of the bar end 500 is opposite to the direction of the extension section 221.

The handlebar 200 is an approximately L-shaped member. The lateral section 223 is made with a diameter of a handle bar of regular bicycle, so that a user can select and mount the appropriate bicycle handle sleeve 400 and bar end 500 according to preference.

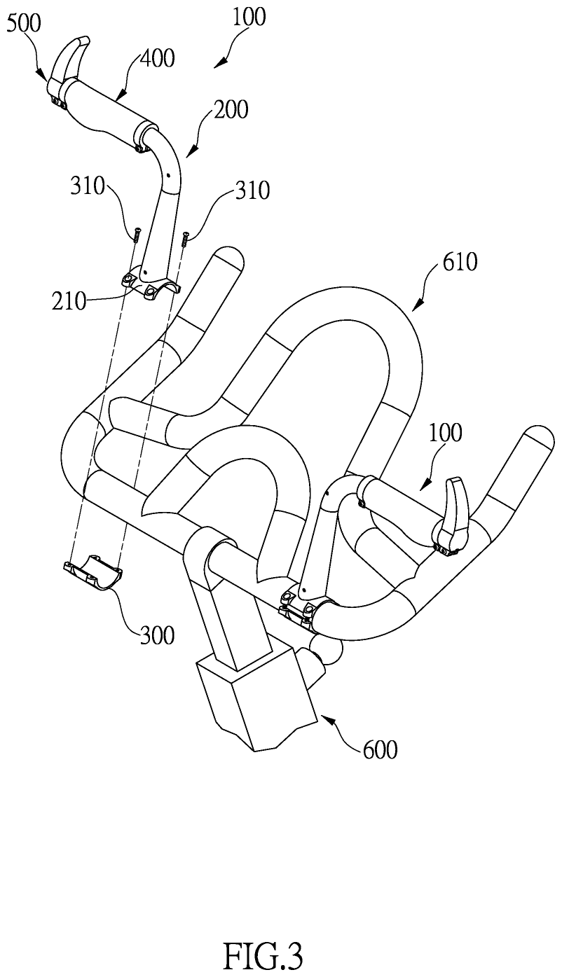

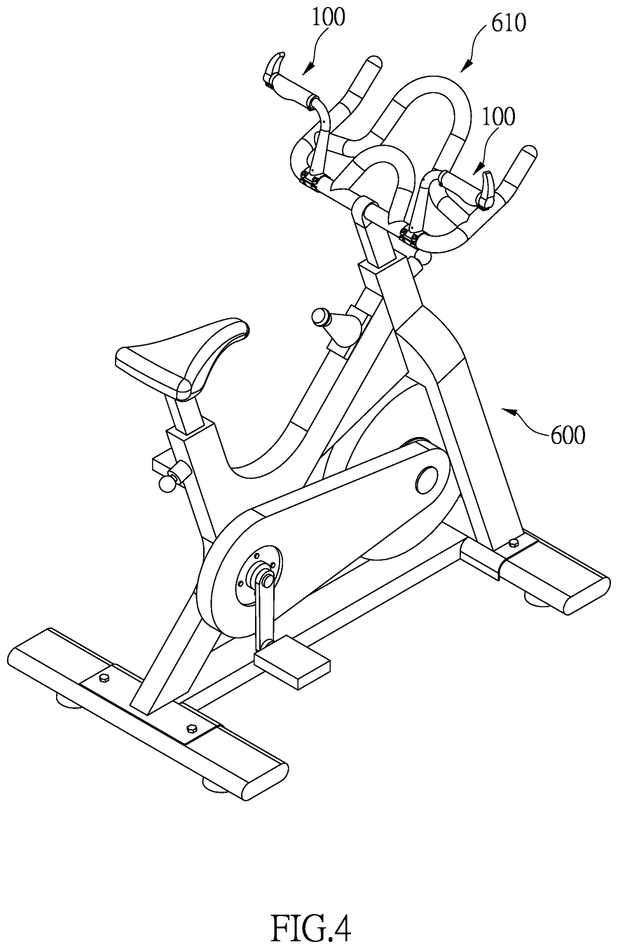

Please refer to FIGS. 3 and 4, which shows operations of mounting an exercise bike auxiliary handle of the present invention. When the grip posture and hand feeling of the original handle 610 of the exercise bike 600 is unsmooth for a user, the user can mount the exercise bike auxiliary handle 100 of the present invention on the exercise bike 600. First, the user determines an appropriate position on the handle 610 of the exercise bike 600, and then uses the fastening part 300 and the clamp part 210 to clamp around the circumferential side of the handle 610, and inserts bolts 310 through the clamp part 210 to screw with the fastening part 300 in a direction from the clamp part 210 to the fastening part 300, so that the fastening part 300 and the clamp part 210 are fastened with the screwing effect of the bolts 310, to make the handlebar 200 movably clamp on the handle 610 by the clamp part 210, the fastening part 300 and the bolts 310. Therefore, the bicycle handle sleeve 400 and the bar end 500 can provide the hand-gripping tactile like a bicycle, and the user can grip the bicycle handle sleeve 400 and the bar end 500 to perform the lower body muscle training.

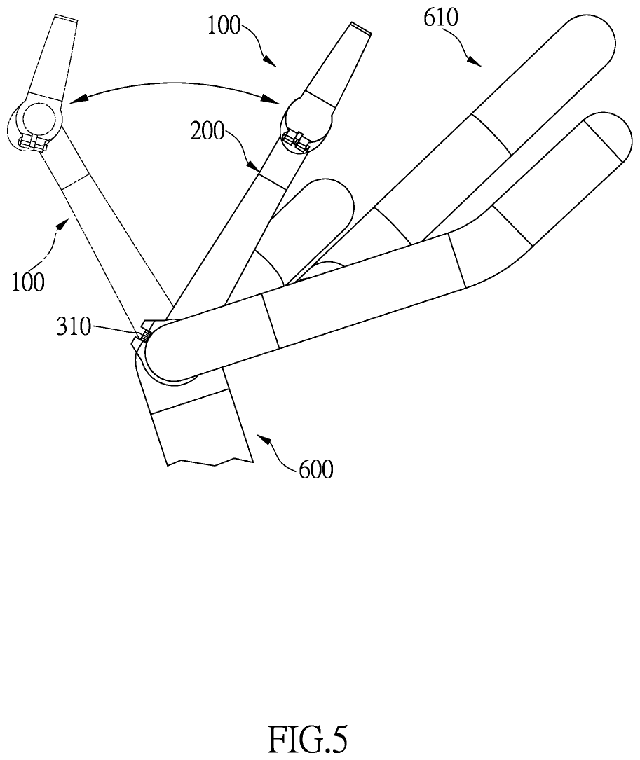

As shown in FIG. 5, the handlebar 200 can be adjusted to swing toward a front side or a back side of the exercise bike 600 before the bolts 310 are fastened, so as to adjust the handlebar 200 to an appropriate gripping position. For example, the right side of FIG. 5 indicates the front side of the exercise bike 600, and the left side of FIG. 5 indicates the back side of the exercise bike 600.

Details of features and assembly relationship of the components of the present invention are illustrated in detail in following paragraphs. The extension section 221 is roughly in a cone shape, and the extension section 221 is gradually extended from the bent section 222 to the clamp part 210, so that the structural strength of the extension section 221 can be improved to resist the force applied in operation, to provide a better stable support for gripping operation.

In regard to detailed structures of the clamp part 210 and the fastening part 300 for clamping and fastening with the handle 610 of the exercise bike 600, the clamp part 210 has an arc clamping surface 211, and the fastening part 300 has an arc fastening surface 301 facing the arc clamping surface 211. By fastening the arc clamping surface 211 and the arc fastening surface 301 on the circumferential side of the handle 610 of the exercise bike 600, the clamp part 210 and the fastening part 300 can correspond to the shape of the circumferential side of the handle 610 and stably mount the exercise bike auxiliary handle 100 of the present invention on the exercise bike 600.

The bicycle handle sleeve 400 includes a fastening part 410 and a holding part 420, and the holding part 420 is made by rubber material and annularly disposed on a peripheral side of the fastening part 410, so that the holding part 420 can provide a stable holding effect.

Furthermore, the fastening part 300 has a hole 302 outwardly cut through the arc fastening surface 301. When the exercise bike auxiliary handle 100 is clamped with the handle 610 of the exercise bike 600, the foam of the handle 610 is forced to deform and a part of the foam can be accommodated and restrained in the hole 302, so as to improve the stability of the exercise bike auxiliary handle 100 clamped with the handle 610.

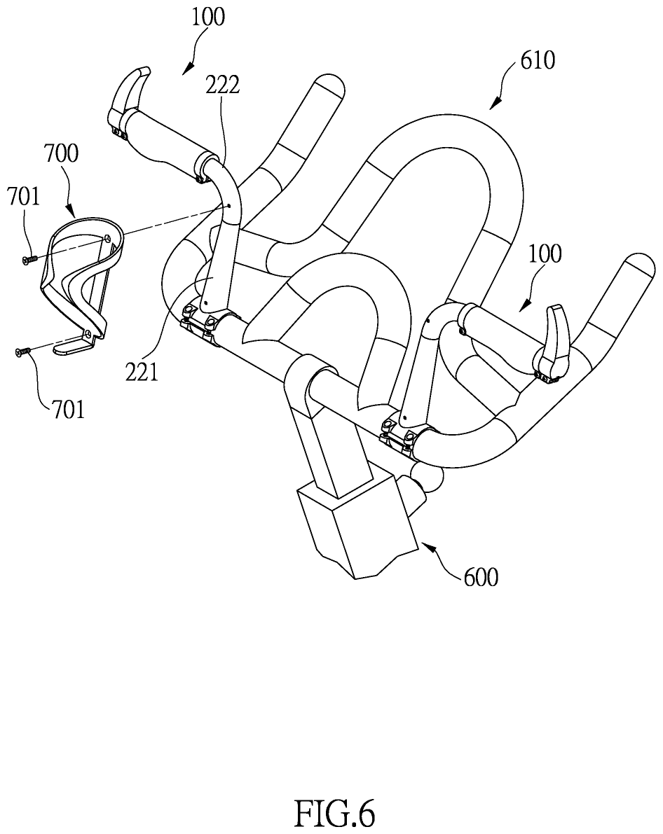

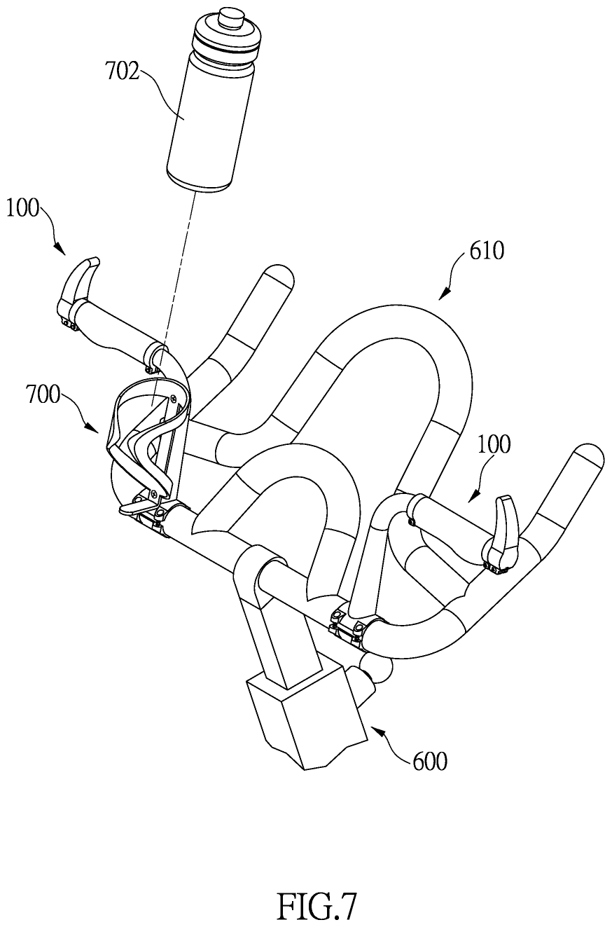

Please refer to FIGS. 6 and 7. The exercise bike auxiliary handle 100 can further include a water bottle cage 700. The water bottle cage 700 is fastened on the same sides of the extension section 221 and the bent section 222 by a plurality of screws 701 inserted therethrough. The screws 701 are screwed and fastened with the extension section 221 and the bent section 222, so that the water bottle cage 700 can be used to place the water bottle 702, and the user can conveniently drink water in the water bottle 702 to replenish lost water during exercise.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An exercise bike auxiliary handle, comprising:
a handlebar comprising a clamp part and a handlebar part, wherein the handle part comprises an extension section, a bent section and a lateral section, and two ends of the bent section are integrally connected to the extension section and the lateral section, and the lateral section comprises a long part and a short part which are integrally connected to each other, and the long part is connected to the bent section;
a fastening part configured to clamp with the clamp part correspondingly, wherein the fastening part and the clamp part are assembled by a plurality of bolts;
a bicycle handle sleeve mounted on a peripheral side of the long part in an axial direction; and
a bar end comprising an end mounted on a peripheral side of the short part.

2. The exercise bike auxiliary handle according to claim 1, wherein the extension section is roughly in a cone shape, and the extension section is gradually extended from the bent section to the clamp part.

3. The exercise bike auxiliary handle according to claim 1, further comprising a water bottle cage, wherein the water bottle cage is fastened on the same sides of the extension section and the bent section by a plurality of screws inserted therethrough.

4. The exercise bike auxiliary handle according to claim 1, wherein the clamp part has an arc clamping surface, and the fastening part has an arc fastening surface facing the arc clamping surface.

5. The exercise bike auxiliary handle according to claim 4, wherein the fastening part has a hole outwardly cut through the arc fastening surface.

6. The exercise bike auxiliary handle according to claim 1, wherein the bicycle handle sleeve comprises a fastening part and a holding part, and the holding part is made by rubber material and annularly disposed on a peripheral side of the fastening part.
